(19) United States
(12) Patent Application Publication
(10) Pub. No.: US 2026/0326731 A1
(43) Pub. Date: Oct. 22, 2026

(54) BRAKING SYSTEM FOR AN AIRCRAFT COMPRISING AN ELECTRICALLY ACTUATED DEVICE CONTROLLED BY A FIRST AND A SECOND CONTROL MEMBER

(71) Applicant: SAFRAN LANDING SYSTEMS, Velizy-Villacoublay (FR)

(72) Inventors: David FRANK, Moissy-Cramayel (FR); Steve COUSTENOBLE, Moissy-Cramayel (FR)

(73) Assignee: SAFRAN LANDING SYSTEMS, Velizy-Villacoublay (FR)

(21) Appl. No.: 19/711,597

(22) Filed: Jun. 17, 2026

Related U.S. Application Data
(63) Continuation of application No. PCT/FR2024/051713, filed on Dec. 18, 2024.

(30) Foreign Application Priority Data
Dec. 22, 2023 (FR) 23/15166

(51) Int. Cl. B60T 13/14; B60T 7/08; B64C 25/44

(52) U.S. Cl. CPC B60T 13/141; B60T 7/08; B64C 25/44; B60T 2220/04

(57) ABSTRACT

A braking system for an aircraft includes at least one electrically actuated device to fill at least one cavity of a brake of the aircraft with hydraulic fluid. The electrically actuated device has a bistable operating mode and a progressive operating mode. The braking system includes at least one first control member for controlling the electrically actuated device and at least one second control member for controlling the electrically actuated device. The first control member generates a parking command that activates the bistable operating mode, and the second control member generates an emergency braking command that activates the progressive operating mode, and the at least one first control member is independent of the at least one second control member.

### CROSS-REFERENCE TO RELATED APPLICATIONS

This application is a continuation of International Application No. PCT/FR 2024/051713, filed on Dec. 18, 2024, which claims priority to and the benefit of French Patent Application No. FR 23/15166 filed on Dec. 22, 2023. The disclosures of the above applications are incorporated herein by reference.

### FIELD

The present disclosure relates to the field of aircraft and more particularly to a braking system and a braking method for an aircraft.

### BACKGROUND

The statements in this section merely provide background information related to the present disclosure and may not constitute prior art.

An aircraft braking system must include a normal braking system, an emergency braking system to supplement the normal braking system during an issue, and a parking braking system making it possible to keep the aircraft stationary.

The emergency braking system must enable a pressure level in the brakes that is variable as a function of a command from a pilot.

The parking braking system must enable maintaining the pressure level in the brakes when the aircraft is stationary and during shutdown of the aircraft.

A hydromechanical form exists that provides a set of members forming part of both the emergency braking system and the parking braking system. This has drawbacks such as: difficulty of installation, the desire for a cable to extend from the aircraft cockpit to a main landing gear bay, the inability to monitor potential issues during operation of the aircraft (jamming or breakage of a cable element), the desire to perform regular maintenance operations (monitoring, lubrication of the cable sheath, etc.), the significant weight of the cable system and its fasteners. There is also an electrically actuated form described in document FR3082503 in which the emergency braking system is at least partially combined with the parking braking system. In this form, a valve provides both progressive emergency braking and on/off parking braking. The valve is controlled by an action on a control lever equipped with a device capable of delivering a voltage proportional to its position. Pulse Width Modulation (PWM) control makes it possible to transform this valve into a proportional valve.

A drawback of this is that parking braking is actuated only after a more or less prolonged period of activation of the emergency braking.

### SUMMARY

This section provides a general summary of the disclosure and is not a comprehensive disclosure of its full scope or all of its features.

A form relates to a braking system for an aircraft comprising at least one electrically actuated device configured to fill at least one cavity of an aircraft brake with hydraulic fluid, the electrically actuated device having, on the one hand, a bistable operating mode in which the hydraulic fluid of the at least one cavity of the brake is maintained at a return pressure or at a supply pressure, and, on the other hand, a progressive operating mode in which the pressure of the hydraulic fluid of the at least one cavity of the brake is comprised between the return pressure and the supply pressure, and at least one first control member of the electrically actuated device, characterized in that the braking system comprises at least one second control member of the electrically actuated device, a movement of the first control member generating a parking command which activates the bistable operating mode, and a movement of the second control member generating an emergency braking command which activates the progressive operating mode, the at least one first control member being independent of the at least one second control member.

The electrically actuated device makes it possible to fill the at least one cavity of the aircraft brake with hydraulic fluid so as to vary a pressure of the hydraulic fluid at the brakes between a return pressure corresponding to no braking, and a supply pressure corresponding to maximum braking.

The electrically actuated device may comprise a valve in which a spool of the valve connects an output port leading to the at least one cavity of the brake to: a return port making it possible to decrease the pressure of the hydraulic fluid, the spool is then defined as being in a passive state, or a supply port making it possible to increase the pressure of the hydraulic fluid, the spool is then defined as being in an active state.

The electrically actuated device may further comprise an electric actuator, such as an electric coil or an electric motor, making it possible to modify the state of the spool.

The electrically actuated device may also comprise a return spring making it possible to return the spool to the passive state when the electric actuator is no longer powered.

The electrically actuated device may function, depending on the received command, according to two modes: the bistable operating mode, that is to say on/off. In this operating mode, the electrically actuated device makes it possible to bring the pressure of the hydraulic fluid at the brake to either the return pressure or the supply pressure. The bistable operating mode is activated by a parking command issued by the first control member; the progressive operating mode in which the pressure of the hydraulic fluid at the brake is comprised between the return pressure and the supply pressure, the pressure of the hydraulic fluid at the brake being dependent on the movement applied by a pilot to the second control member. The progressive operating mode is activated by an emergency braking command.

The progressive operating mode may be achieved by a PWM control.

For example, the electrically actuated device may be of the type described in document FR3 082 503.

The first and second control members are independent of each other. In other words, any action, real or virtual, exerted on the first control member does not result in any action on the second control member. The parking command is therefore issued independently of the emergency braking command. There is a complete separation between the parking and emergency braking commands, which may therefore be of a different nature.

The first and/or second control member may be a virtual control member.

Preferably, the first and/or second control member may be a physical member, for example, one that may be manually held by the aircraft pilot. Thus, the at least one first control member is physically independent of the at least one second control member.

The first and/or second control member may be positioned in the aircraft cockpit so as to be accessible to the pilot.

A movement of the control member corresponds to the successive positions taken by the first and/or second control member in space over time.

Each of the first control member and of the second control member may be positioned in at least one return position in which the control member sends a command to the electrically actuated device to bring the pressure of the hydraulic fluid at the brake to the return pressure.

Each of the first control member and of the second control member may be positioned in at least one supply position in which the control member sends a command to the electrically actuated device to bring the pressure of the hydraulic fluid at the brake to the supply pressure.

When the first control member is actuated, a parking command is sent to the electrically actuated device. The parking command activates the bistable operating mode, thus bringing the hydraulic fluid to the supply pressure or to the return pressure.

When the second control member is actuated, an emergency braking command is sent to the electrically actuated device. The emergency braking command activates the progressive operating mode, thus bringing the hydraulic fluid to a value varying between the supply pressure and the return pressure.

According to some forms, the first and/or second control member may be positioned in a rest position in which none of the operating modes of the electrically actuated device are actuated. In other words, in the rest position, the electrically actuated device is not activated.

The braking system according to the present disclosure separates the control members and the generated commands making it possible to control each of the two operating modes. Therefore, there is no risk of triggering the progressive operating mode before using the bistable operating mode, and vice versa. The control of the braking system is thus more reliable.

The subject of the present disclosure may also have one or several of the following features, taken alone or in combination.

In some forms, a type of the first control member is different from a type of the second control member.

A type of the first and/or second control member corresponds to a set of physical features making it possible to distinguish the first and/or second control member.

The first and/or second control member may be of any type, such as: a lever, a trigger, a rotary knob, or a quarter-turn lever, also referred to as a “pull and turn” lever. For example, the first control member is a push button that can be pressed relative to the reference frame in which the control member is in use. This action will generate the parking command and actuate the bistable operating mode. Independently, the second control member could be a lever that can be pulled upward relative to the reference frame in which the control member is in use. This action will generate the emergency braking command and actuate the progressive operating mode.

In some forms, the first and/or second control member comprises a measurement sensor configured to detect a position or force exerted on the control member.

Preferably, the second control member comprises the measurement sensor.

Thus, the second control member, by means of the measurement sensor, may generate and transmit the emergency braking command depending on the position or force exerted on the second control member.

The dependence may be a proportional or multi-slope relationship between a value of the emergency braking command, and the position or force exerted on the second control member.

The pilot may therefore easily vary the progressive braking by modifying more or less the position of, or the force exerted on, the second control member.

In some forms, the braking system also comprises at least one activation device configured to fully or partially energize the electrically actuated device.

The activation device is a safety device provides that a simple issue does not result in unintended braking.

For this purpose, the activation device comprises an activated state in which the electrically actuated device is energized and a deactivated state in which the electrically actuated device is partially or totally de-energized.

When the electrically actuated device is energized, the electrically actuated device may modify the pressure of the hydraulic fluid as a function of the received parking command or emergency braking command.

When the electrically actuated device is completely or partially de-energized, the electrically actuated device cannot be controlled. In other words, the electrically actuated device cannot modify the pressure of the hydraulic fluid as a function of the received parking command or emergency braking command.

Each of the first and second control members may comprise an activation device.

The braking system therefore comprises two activation devices.

Alternatively, the first or second control member comprises an activation device.

Alternatively, the braking system comprises an activation device common to the first and second control members.

In some forms, the at least one activation device is a trigger, or a button.

In some forms, the at least one activation device has the function of an electric switch.

Thus, when the activation device is activated, that is to say brought in the activated state, it energizes the electrically actuated device. When the activation device is deactivated, that is to say brought in the deactivated state, it totally or partially de-energizes the electrically actuated device.

For example, the activated state is obtained by pressure exerted on the activation device, whereas the deactivated state is the state of the activation device when no force is exerted on the activation device or following successive presses.

In some forms, the at least one activation device is configured to generate an activation command making it possible to control an electric switch.

The at least one activation device then generates an activation command which actuates an electric switch, the electric switch enabling the electrically actuated device to be energized.

In some forms, the at least one activation device is implemented by a flight computer.

The flight computer generates a (total or partial) energization or de-energization of the electrically actuated device according to, for example, an aircraft operation phase, or a request from the pilot.

In some forms, the activation device is positioned on the first and second control members.

In some forms, the braking system also comprises at least one mechanical or electromagnetic locking device configured to inhibit movement of the first and/or second control member.

In some forms, each of the first and second control members may comprise a mechanical or electromagnetic locking device.

The braking system therefore comprises two mechanical or electromagnetic locking devices.

Alternatively, the first or second control member comprises a mechanical or electromagnetic locking device.

Alternatively, the braking system comprises a mechanical or electromagnetic locking device common to the first and second control members.

The mechanical or electromagnetic locking device may hold the first and/or second control member in its position.

The mechanical or electromagnetic locking device comprises a locked state in which the position of the control member cannot be modified. Preferably, in the locked state, the mechanical or electromagnetic locking device locks the considered control member in the rest position.

The mechanical or electromagnetic locking device comprises an unlocked state in which a position of the control member may be modified so as to generate a parking command or an emergency braking command to activate one of the operating modes of the electrically actuated device.

In some forms, the activation device and the mechanical or electromagnetic locking device are combined, that is to say an action on the activation device also brings the mechanical or electromagnetic locking device in the unlocked state.

Another aspect of the present disclosure relates to a braking method for an aircraft comprising a braking system according to the present disclosure, implementing: Controlling a parking braking, in which a pilot actuates the first control member; Controlling an emergency braking, in which the pilot actuates the second control member.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic representation of a braking system according to the present disclosure;

FIG. 2 is a schematic representation of an activation device according to a first form; and

FIG. 3 is a schematic representation of an activation device according to a second form.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Only the elements necessary for understanding the present disclosure have been represented. To facilitate reading of the drawings, the same elements bear the same references from one figure to another.

It should be noted that in this document, the terms “front”, “back”, “right”, “left”, “top”, “bottom”, used to describe a direction of movement of the control member refer to the movement of the control member in use relative to an aircraft pilot.

The present disclosure relates to a braking system 1 for an aircraft.

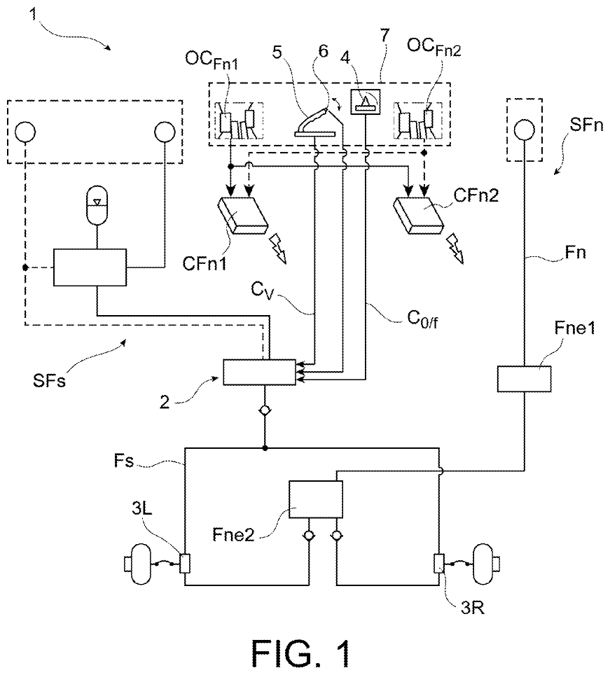

In FIG. 1, the aircraft comprises two wheels L, R, each being connected to a brake cavity 3R, 3L. During braking, the cavities 3L, 3R are filled with a hydraulic fluid Fn, Fs. When the pressure of the hydraulic fluid Fn, Fs at the cavities 3L, 3R of the brakes is equal to a return pressure, no braking is performed, in other words braking at 0%.

When the pressure of the hydraulic fluid Fn, Fs at the cavities 3L, 3R of the brakes is equal to a supply pressure, braking at a maximum level is performed, in other words, braking at 100%.

When the pressure of the hydraulic fluid Fn, Fs at the cavities 3L, 3R of the brakes is comprised between the supply pressure and the return pressure, a braking at a variable level is performed, in other words a braking varying between 0% and 100%.

The braking system 1 comprises a normal braking subsystem configured to provide braking at a variable level, that is to say between 0% and 100%. To achieve this, the normal braking subsystem comprises a normal control portion that generates a command intended to pilot a normal hydraulic portion SFn, the normal hydraulic portion SFn varies the pressure of the hydraulic fluid Fn between 0% and 100%. The normal control portion comprises at least one first controller OC_{Fn1}, which generates a command transmitted by a first computer CFn1 to the normal hydraulic portion. Redundantly, in case of an issue with the first controller OC_{Fn1} and/or of the first computer CFn1, the normal control portion also comprises an emergency controller OC_{Fn2}, which may generate a command which will be transmitted by an emergency computer CFn2 to the normal hydraulic portion.

The normal hydraulic portion SFn comprises a plurality of elements Fne1, Fne2, making it possible to vary the pressure of the hydraulic fluid Fn at the cavities 3L, 3R of the brakes between the supply pressure and the return pressure.

There are many ways to implement the normal braking subsystem, the elements described are just one example.

The braking system 1 also comprises an emergency and parking braking subsystem which is intended to provide, on the one hand, emergency braking at a variable level, and, on the other hand, parking braking at the supply pressure.

For this purpose, the emergency braking and parking subsystem comprises in particular an emergency hydraulic portion SFs which is provided with an electrically actuated device 2.

The electrically actuated device 2 may comprise a valve in which a spool of the valve connects an output port of the emergency hydraulic portion SFs leading to the at least one cavity 3L, 3R of the brake to: a return port of the emergency hydraulic portion SFs, making it possible to decrease the pressure of the hydraulic fluid Fs, the spool is then defined as being in a passive state, or a supply port of the emergency hydraulic portion SFs, making it possible to increase the pressure of the hydraulic fluid Fs, the spool is then defined as being in an active state.

The electrically actuated device 2 may further comprise an electric actuator, such as an electric coil or an electric motor, making it possible to modify the state of the spool.

The electrically actuated device 2 may also comprise a return spring making it possible to return the spool to the passive state when the electric actuator is no longer powered.

The electrically actuated device 2 may operate according to two modes: a bistable operating mode, that is to say on/off. In this operating mode, the electrically actuated device 2 makes it possible to bring the pressure of the hydraulic fluid Fs at the cavity 3R, 3L of the brake to the return pressure or to the supply pressure. The bistable operating mode is activated by a parking command C_{o/f} which is issued by a first control member 4; a progressive operating mode in which the pressure of the hydraulic fluid Fs at the cavity 3R, 3L of the brake is comprised between the return pressure and the supply pressure. The progressive operating mode is activated by an emergency braking command Cᵥ which is issued by a second control member 5.

The progressive operating mode may be achieved by a PWM control.

For example, the electrically actuated device 2 may be of the type described in document FR3 082 503.

The first control member 4 and the second control member 5 are independent of each other. In other words, any action, real or virtual, exerted on the first control member 4 does not result in any action on the second control member 5. The parking command C_{o/f} is therefore issued independently of the emergency braking command Cᵥ. There is a complete separation between the parking command C_{o/f} and the emergency braking command Cᵥ which may therefore be of a different nature.

The first 4 and/or second 5 control member may be a virtual control member.

Preferably, the first 4 and/or second 5 control member may be a physical member as illustrated in FIG. 1, for example, one that can be held manually by an aircraft pilot. The first 4 and/or second 5 control member may be positioned in an aircraft cockpit 7 so as to be accessible to the pilot.

A movement of the control member 4 corresponds to the successive positions taken by the first 4 and/or second 5 control member in space over time.

Each of the first control member 4 and of the second control member 5 may be positioned in at least one return position in which the control member 4, 5 sends a command to the electrically actuated device 2 to bring the pressure of the hydraulic fluid Fs at the brake to the return pressure. In other words, the return position of the control member 4, 5 corresponds to a command to maintain the hydraulic fluid Fs of the at least one cavity 3L, 3R of the brake at the return pressure.

Each of the first control member 4 and of the second control member 5 may be positioned in at least one supply position in which the control member 4, 5 sends a command to the electrically actuated device 2 to bring the pressure of the hydraulic fluid Fs at the brake to the supply pressure. In other words, the supply position corresponds to a command to maintain the hydraulic fluid Fs of the at least one cavity 3L, 3R of the brake to the supply pressure.

Finally, each of the first control member 4 and of the second control member 5 may be positioned in a rest position in which no command is sent to the electrically actuated device 2. In other words, when the control member 4, 5 is in the rest position, none of the operating modes of the electrically actuated device 4 are activated.

According to the present disclosure, the first control member 4 generates a parking command C_{o/f} which activates the bistable operating mode, and the second control member 5 generates an emergency braking command Cᵥ which activates the progressive operating mode, the at least one first control member 4 being independent of the at least one second control member 5. When the first control member 4 is actuated, the parking command C_{o/f} is sent to the electrically actuated device 2. The parking command C_{o/f} activates the bistable operating mode and thus brings the hydraulic fluid Fs to the supply pressure or to the return pressure.

When the second control member 5 is actuated, the emergency braking command Cᵥ is sent to the electrically actuated device 2. The emergency braking command Cᵥ activates the progressive operating mode and therefore brings the hydraulic fluid Fs to a value varying between the supply pressure and the return pressure.

Thus, the braking system 1 according to the present disclosure separates the control members and the commands making it possible to control each of the two operating modes. Therefore, there is no risk of triggering the progressive operating mode before using the bistable operating mode, and vice versa. The control of the braking system is thus more reliable.

In some forms, a type of the first control member 4 is different from a type of the second control member 5.

A type of the first 4 and/or second 5 control member corresponds to a set of physical features making it possible to distinguish the first 4 and/or second 5 control member.

The first 4 and/or second 5 control member may be of any type such as: a lever, a trigger, a rotary knob, a quarter-turn lever, also referred to as “Pull and Turn” lever.

In some forms, the control member 4 comprises a measurement sensor configured to detect a position or force exerted on the control member 4, 5.

Preferably, the second control member 5 comprises the measurement sensor.

Thus, the second control member 5, by means of the measurement sensor, may generate and transmit the emergency braking command Cᵥ depending on the position or force exerted on the second control member 5.

The dependence may be a proportional or multi-slope relationship between a value of the emergency braking command Cᵥ and the position or force exerted on the second control member 5. The pilot may therefore easily vary the progressive braking by modifying more or less the position of, or the force exerted on the second control member 5.

For example, and as illustrated in FIG. 1, the second control member 5 is a lever that can be pulled upwards, the second control member 5 generates the emergency braking command Cᵥ varying between 0% and 100%, which activates the progressive operating mode and thus an emergency braking. Independently, the first control member 4 is a push button that can be pressed, the first control member 4 generates the parking command C_{o/f} varying over a range comprised between 0% and −10%, any parking command C_{o/f} comprised between −10% and −5% will then be interpreted as a request to activate the parking brake, that is to say to bring the hydraulic fluid Fs to the supply pressure, while any parking command C_{o/f} comprised between −5% and 0% will then be interpreted as a request to deactivate the parking brake, that is to say to bring the hydraulic fluid Fs to the return pressure.

In some forms, the braking system 1 also comprises at least one activation device 6 configured to energize or de-energize the electrically actuated device 2.

The activation device 6 is a safety device providing that a simple issue does not result in unintended braking.

For this purpose, the activation device 6 comprises an activated state in which the electrically actuated device 2 is energized and a deactivated state in which the electrically actuated device 2 is partially or totally de-energized.

When the electrically actuated device 2 is energized, the electrically actuated device 2 may modify the pressure of the hydraulic fluid Fs as a function of the received parking command C_{o/f} or emergency braking command C.

When the electrically actuated device 2 is de-energized, the electrically actuated device 2 cannot be controlled. In other words, the electrically actuated device 2 cannot modify the pressure of the hydraulic fluid Fs as a function of the received parking command C_{o/f} or emergency braking command Cᵥ.

Each of the first 4 and second 5 control members may comprise an activation device. In the figure illustrated in FIG. 1, only the second control member 5 comprises an activation device 6.

Alternatively, the first 4 or second 5 control member comprises an activation device 6.

Alternatively, the braking system 1 comprises an activation device common to the first 4 and second 5 control members.

In some forms, the at least one activation device 6 is a trigger, or a button.

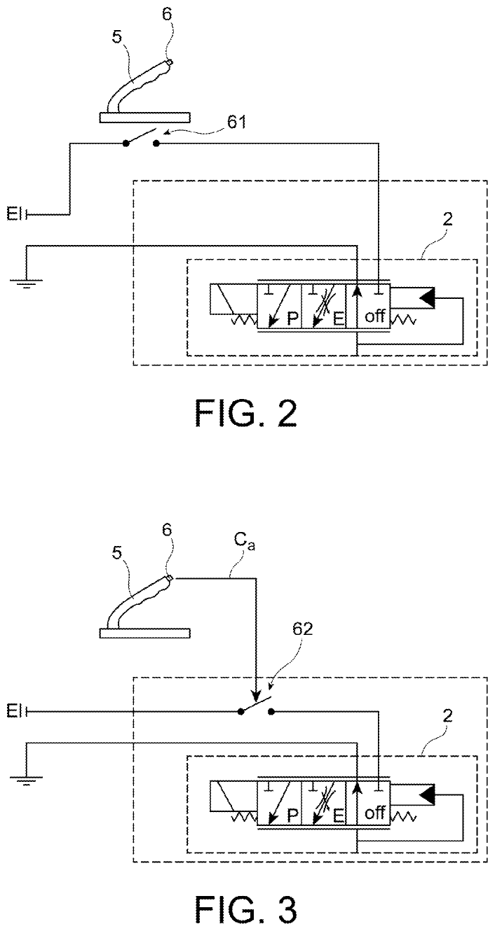

In some forms, the at least one activation device 6 has the function of an electric switch 61 as illustrated in FIG. 2.

Thus, when the activation device 6 is activated, that is to say brought into the activated state, it energizes the electrically actuated device 2, that is to say it connects a power supply El to the electrically actuated device 2.

When the activation device 6 is deactivated, that is to say brought in the deactivated state, it de-energizes the electrically actuated device 2, that is to say it cuts the link between the power supply El and the electrically actuated device 2.

For example, the activated state is obtained by pressure exerted on the activation device 6, whereas the deactivated state is the state of the activation device 6 when no force is exerted on the activation device 6.

In some forms, the at least one activation device 6 is configured to generate an activation command Ca making it possible to control an electric switch 62, as illustrated in FIG. 3.

The at least one activation device 6 then generates an activation command Cₐ which actuates an electric switch 62, the electric switch 62 enabling an energization of the electrically actuated device 2, that is to say its link with the power supply El.

In some forms, the at least one activation device 6 is implemented by a flight computer.

The flight computer generates a total or partial energization or de-energization of the electrically actuated device 2 according to, for example, an aircraft operation phase, or a request from the pilot.

In some forms, the braking system also comprises at least one mechanical or electromagnetic locking device configured to inhibit movement of the control member 4.

The mechanical or electromagnetic locking device may inhibit movement of the first 4 and/or second 5 control member.

In some forms, each of the first 4 and second 5 control members may comprise a mechanical or electromagnetic locking device.

For example, the mechanical or electromagnetic locking device of the first control member 4 may be a cover that must be removed to maneuver said control member. Alternatively, the first 4 or second 5 control member comprises a mechanical or electromagnetic locking device.

Alternatively, the braking system 1 comprises a mechanical or electromagnetic locking device common to the first 4 and second 5 control members.

The mechanical or electromagnetic locking device may hold the first 4 and/or second 5 control member in its position.

The mechanical or electromagnetic locking device comprises a locked state in which a position of the considered control member 4, 5 cannot be modified. Preferably, in the locked state, the mechanical or electromagnetic locking device locks the considered control member 4, 5 in the rest position.

The mechanical or electromagnetic locking device comprises an unlocked state in which a position of the considered control member 4, 5 may be modified so as to activate one of the operating modes of the electrically actuated device 2.

In some forms, the activation device 6 and the mechanical or electromagnetic locking device are combined, that is to say that an action on the activation device 6 also brings the mechanical or electromagnetic locking device in the unlocked state.

Another aspect of the present disclosure relates to a braking method for an aircraft comprising a braking system 1 according to the present disclosure, implementing: Controlling a parking braking in which a pilot actuates the first control member 4; and controlling an emergency braking in which the pilot actuates the second control member 5.

Although the present disclosure has been described with reference to specific forms, it is evident that modifications and changes may be made to these examples without departing from the general scope of the present disclosure as defined by the claims. In particular, individual features of the various illustrated/mentioned examples may be combined in additional variations. Therefore, the description and drawings should be considered in an illustrative rather than restrictive sense.

It is also evident that all the features described with reference to a method are transposable, alone or in combination, to a device, and conversely, all the features described with reference to a device are transposable, alone or in combination, to a method.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A braking system for an aircraft, comprising:
at least one electrically actuated device configured to fill at least one cavity of an aircraft brake with a hydraulic fluid, the at least one electrically actuated device having a bistable operating mode in which the hydraulic fluid of the at least one cavity of the aircraft brake is maintained at a return pressure or at a supply pressure, and a progressive operating mode in which a pressure of the hydraulic fluid of the at least one cavity of the aircraft brake is maintained between the return pressure and the supply pressure;
at least one first control member associated with the at least one electrically actuated device; and
at least one second control member associated with the at least one electrically actuated device, the at least one first control member is independent of the at least one second control member,
wherein a movement of the at least one first control member is configured to generate a parking command that activates the bistable operating mode, and a movement of the at least one second control member is configured to generate an emergency braking command that activates the progressive operating mode.

2. The braking system according to claim 1, wherein a type of the at least one first control member is different from the type of the at least one second control member.

3. The braking system according to claim 1, wherein at least one of the at least one first control member and the at least one second control member comprises a measurement sensor configured to detect a position or force exerted on the at least one of the at least one first control member and the at least one second control member.

4. The braking system according to claim 1, further comprising at least one activation device configured to energize the at least one electrically actuated device.

5. The braking system according to claim 4, wherein the at least one activation device has the function of an electric switch.

6. The braking system according to claim 4, wherein the at least one activation device is configured to generate an activation command to control an electric switch.

7. The braking system according to claim 4, wherein the at least one activation device is implemented by a flight computer.

8. The braking system according to claim 4, wherein the at least one activation device is positioned on at least one of the at least one first control member and the at least one second control member.

9. The braking system according to claim 1, further comprising at least one mechanical locking device or electromagnetic locking device configured to inhibit movement of at least one of the at least one first control member and the at least one second control member.

10. A braking method for an aircraft including a braking system according to claim 1, the braking method comprising:
controlling a parking braking in which a pilot actuates the at least one first control member; and
controlling an emergency braking in which the pilot actuates the at least one second control member.
